(19) United States
(12) Patent Application Publication
(10) Pub. No.: US 2003/0016529 A1
(43) Pub. Date: Jan. 23, 2003

(54) Illuminated lollipop or candy sucker

(76) Inventors: Wendy Ann Schuren, Randolph, NJ (US); Martin David Warren, Flemington, NJ (US)

Correspondence Address: Wendy A. Schuren, 30 Barbara Drive, Randolph, NJ, 07869, US

(21) Appl. No.: 09/910,127

(22) Filed: Jul. 21, 2001

(51) Int. Cl. F21V 33/00

(52) U.S. Cl. 362/109; 362/253

(57) ABSTRACT

A lollipop or sucker candy, herein referred to as “pop,” is illuminated from the inside of the pop which produces a glowing or illuminated effect when viewing the pop from the outside of the pop, when combined with a miniature flashlight.

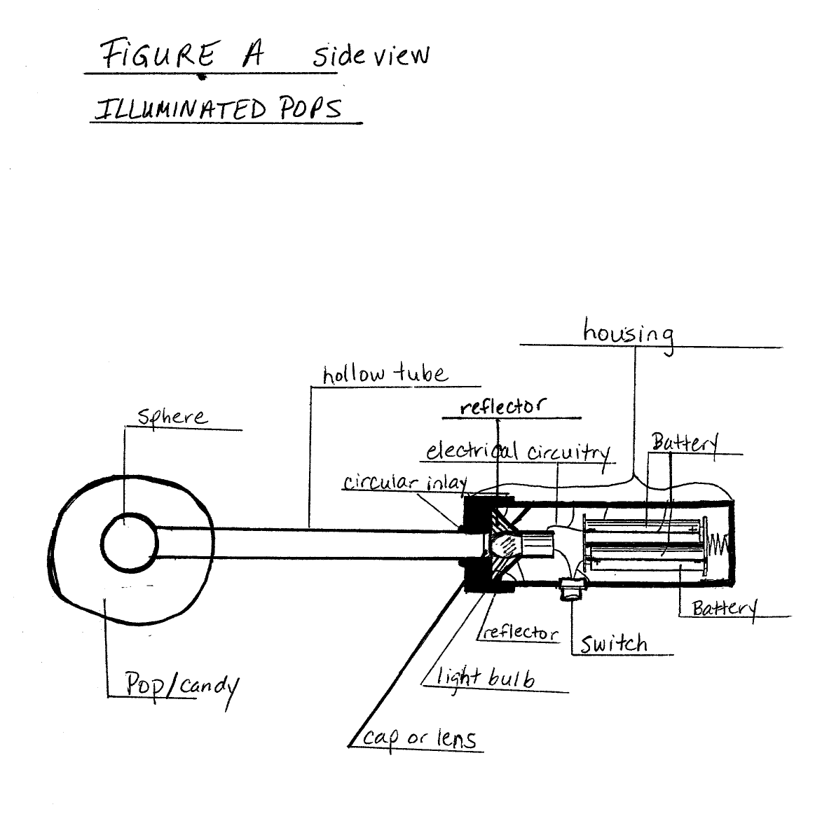

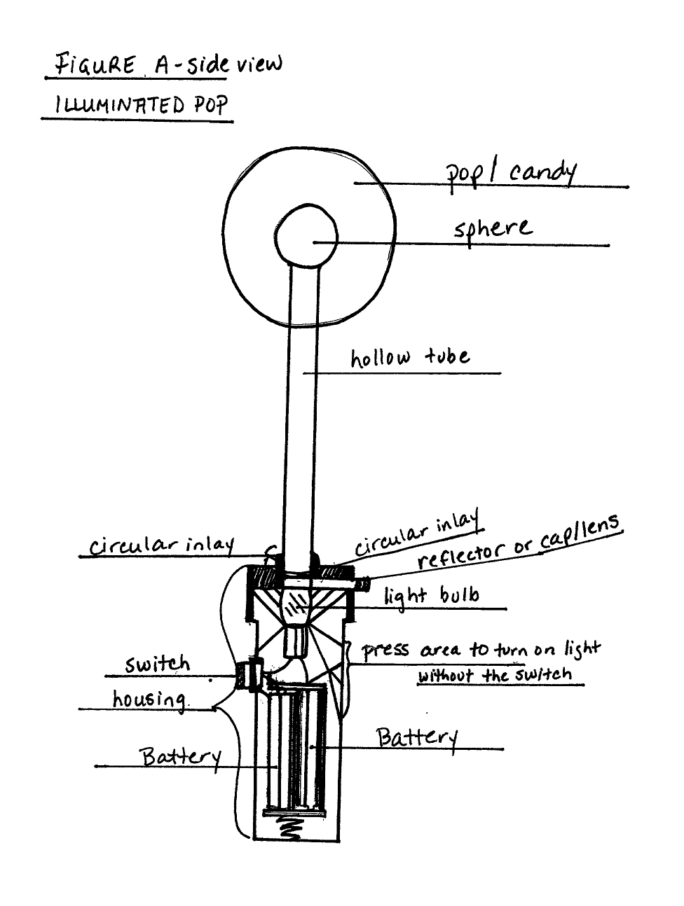

### BACKGROUND OF THE INVENTION

This invention utilizes a flashlight in combination with a piece of candy, as outlined in the claims above, to illuminate a piece of candy from the inside, creating an illuminated or glowing effect on the outside of the candy, which can be consumed while illuminated.

Prior art (U.S. Pat. No. 6,135,606) claims to illuminate a piece of candy from the interior, however, it utilizes fiber-optic elements inside the tubular stem. As prior art indicates, the light is “conducted through the fiber-optics elements to different spots inside the transparent tubular holding stem.” Our invention does not utilize fiber optics. In addition, the colored lenses mentioned in this prior art is not similar to the colored lenses utilized in our invention because it emits light to the outer surface of the candy. As prior art states, “color light beams illuminating the outer surface of the candy attached over the toy when it is in use, making the candy to glow in an attractive way . . . ” Prior art also indicates it is “water tight assembled allowing to wash it thoroughly under a water stream to guarantee the required hygienic condition to be reused many times.” Our invention is not water tight and should not be immersed in water. This contributes significantly to a difference in these two inventions as the task of waterproofing can be complex and costly making the manufacture of such an item too costly to ensure a profit on the free market. Prior art also specifies illumination via tiny blinking light spots. Our invention does not employ a blinking light effect other than when the user chooses to repeatedly turn the illumination on and off rapidly—which is not part of the product design. Prior art also states, in the Description of the Preferred Embodiment, that the LED's or miniature light bulbs are placed directly inside of the tubular stem. Our invention proposes that the light emitting source be contained in the housing or flashlight, not the hollow tube or tubular stem. This, again, is a difference between prior art and our invention since the light emitting source in our invention is contained and enclosed in the housing, further ensuring safety by separating the light emitting source farther from the edible area.

Prior art (U.S. Pat. No. 4,914,748) utilizes a flashlight with a candy sucker for the purpose of illuminating the candy. However, the candy is not illuminated from the inside. As stated in the detailed description of this invention, the “elongated piece of transparent candy (26) having the shape of the connector on one end is slid into the connector for securing the candy to the connector and flashlight.” The purpose of this invention is to illuminate a candy holding device, to which the candy is placed inside.

Prior art (U.S. Pat. No. 5,471,373) utilizes a light flashing device to pulsate on the users face. In this case, the pop or candy is not being illuminated from the inside of the pop or candy to produce the illumination.

Prior art (U.S. Pat. No. 5,921,841) utilizes a cylindrical tube containing a luminescent colored liquid that flows freely through the tube from one end to another. Our invention does not propose the use of a liquid flowing freely through the handle of the hollow tube.

Prior art (U.S. Pat. No. 5,615,941) utilizes a dual lollipop holder with a lollipop compartment at both ends.

None of the prior art, as we have interpreted, claims to illuminate a lollipop from the inside using a hollow tube and optionally, a sphere, to illuminate the pop as cited in the claims above. The sphere inside the pop is used to increase the intensity of the light and diffuse the light to create an intense, evenly-lit pop or candy. Without the sphere or any type of diffuser, the light will most likely continue traveling toward the top or opposite end of the pop or candy, and concentrate at the top or end only. The light will mainly be viewable by looking downward at the top of the pop or at the end of the pop, where most of the intensity is concentrated. Without a diffuser, the pop may not appear intensely-lit when viewing the pop from all its other sides. The sphere or diffuser, although recommended, is optional. This same “diffusing effect” can be added to the hollow tube.

In addition, the light source as outlined in claim 1, has been kept at a safe distance from the edible area of the pop since it is separated by a hollow tube, similar to what consumers are accustomed to, which is a lollipop stick. The light bulb is enclosed in the housing and the light is conducted through a clear encasing up the hollow tube.

### BRIEF SUMMARY OF THE INVENTION

This invention utilizes a flashlight to illuminate a lollipop or candy sucker, herein referred to as “pop”. Pops have long been a popular confectionery item. This invention adds a source of entertainment while the user is consuming the pop.

The user can illuminate the pop by turning on the switch, located on the flashlight or by pressing a pre-determined area on the flashlight which will trigger the electrical apparatus, and in turn, illuminate the pop. While the designated area is pressed, the light and pop remain illuminated. When the user depresses the designated area on the flashlight, the light will cease to illuminate. The user may find enjoyment by pressing the designated area at will, thereby creating some sort of pattern or blinking light effect.

The user may also replace the hollow tube and pop with another hollow tube and pop after the pop has been consumed, if the hollow tube has been designed so that is replaceable. The replaceability is an optional feature.

The pop may also be manufactured so that the hollow tube and/or sphere contains phosphorescent material so that the tube and sphere “glow” when illuminated and may glow after the light source has been turned off. This can provide the user with added enjoyment while the pop is being consumed and long after the pop has been consumed.

### BRIEF DESCRIPTION OF THE DRAWING

FIG. A

FIG. A depicts a side-view of this invention. The rectangular shape is the housing. The housing may be of any shape or design. Included within the housing is the battery, electrical circuitry and light bulb. The light bulb is located toward the top of the housing and at the base of the hollow tube. A cap (or lens) separates the hollow tube from the housing. The switch is located on the exterior of the housing. The bottom of the housing can be opened to replace the battery.

The hollow tube is either screwed or snapped into place at the top of the housing. In this diagram, the hollow tube is connected to a hollow sphere, however, as mentioned the sphere is optional. The sphere and tube may be manufactured together as one piece.

### DETAILED DESCRIPTION OF THE PREFERRED EMBODIMENT

This invention utilizes an inexpensive flashlight that has been modified to include a circular inlay at the top end of the housing near the light bulb. The light bulb is enclosed in the housing. The inlay is so that a hollow tube can be inserted or screwed on securely. The flashlight includes a closed end (at the bottom) and another closed end that consists of a clear or transparent cap that rests at the top of the housing. The clear or transparent cap will allow light to pass through without any diffusion or interference. The purpose of the cap is to prevent access to the light bulb, and keep the area free of moisture related to the consumption of the pop, such as saliva, etc.

A switch is located on the outside of the flashlight to control illumination (and optionally vibration) from the “on” and “off” position. As with any flashlight, this must consist of a least one battery source which supplies current to the bulb via an electrical conductor that extends from the end of the battery to the center contact of the bulb. A switch on the electrical circuit extends from the battery to the contact of the bulb in order to control the current to the bulb. Optionally, the flashlight can contain a designated area in which the consumer can press to trigger the electrical current which will illuminate the light bulb. The pop will remain illuminated when this area is pressed. The pop will cease to illuminate when the designated area is depressed.

A hollow tube, which can be any length, but optimally-sized to conduct light effectively is connected to the flashlight by means of the inlay described above. The hollow tube may or may not contain a sphere which is located at the opposite end of the housing and resides in the pop. The hollow tube and sphere can be manufactured together, but it is not necessary. If the sphere is not manufactured as a part of the hollow tube, and is attached later, precautions must be taken so that the sphere cannot be detached from the hollow tube during consumption. The hollow tube and sphere can be made of a hard plastic or acrylic material. Optionally, these can be manufactured with phosphorescent material so that one or both can “glow.” The hollow tube may or may not be opaque. If the hollow tube is transparent or translucent, the tube will also light up. This may lessen the intensity of light emanating from the pop. The sphere should be translucent, similar to a “frosted” effect. This will diffuse the light so that it enables the pop to be evenly-lit. The pop can be manufactured on the sphere, similar to the way it adheres to a lollipop stick. The pop should be as transparent or translucent as possible to enable light to pass through the pop for the most intense illumination. The pop can be of any size, shape or design.

We claim:

1. An illuminated pop which comprises;
A. a flashlight, of any shape or size, but preferably hand-held that includes:
a housing,
an electrical source in said housing,
a light bulb at the top of the housing, but still contained in the housing,
electrical circuitry for operating the electrical source and light bulb,
a circular inlay around the top of the housing near the light bulb so that a hollow tube can be screwed or snap securely into place, so that light may be conducted into the hollow tube from said housing when in operation,
B. A hollow, opaque tube which is connected to the flashlight on one end, as set forth in claim 1A, so that the hollow tube may conduct light up into a small sphere located at the opposite end of the tube (opposite the housing) and resides inside the pop, and is used to diffuse light,
C. A translucent lollipop or candy sucker (“pop”) of any shape, design, size, flavor, etc. which is attached to, or manufactured on, the sphere, as set forth in claim 1B, whereby light conducted up through the hollow tube into the sphere, illuminates the pop.

2. An illuminated pop as set forth in claim 1, wherein;
the hollow tube and sphere may be of any shape, size, design, color; the hollow tube may be translucent; and both the hollow tube and sphere may contain a phosphorescent material which would allow the tube and sphere to “glow” while illuminated and after the light source has been turned off.

3. An illuminated pop as set forth in claim 1, wherein;
the flashlight, hollow tube and sphere can be used as an entertainment device after the pop has been consumed.

4. An illuminated pop as set forth in claim 1, wherein,
the hollow tube (including sphere) and pop are replaceable so that the user can replace the hollow tube and pop after the pop has been consumed with another hollow tube and unconsumed pop. This is optional.

5. An illuminated pop as set forth in claim 1, wherein;
A. the flashlight can be turned on by means of a switch, or
B. the user can press a pre-set area on the flashlight, which in turn, triggers the electrical source and circuitry to turn on the light bulb. In this instance, the user can press the designated area quickly and/or sporadically to create a patterned and/or blinking effect. This is optional.

6. An illuminated pop as set forth in claim 1, wherein;
the flashlight may also create a vibration sensation via another switch. The vibration can be characterized as a slight quivering motion. This is also created from the same electrical source. This is optional.

7. An illuminated pop as set forth in claim 1, wherein; the sphere may contain materials to enhance the illumination, such as reflectors,etc. The sphere in claim 1B and 1C is optional.

8. An illuminated pop as set forth in claim 1, wherein;
the clear or translucent cap that separates the flashlight from the hollow tube may be a colored lens consisting of any one color or a combination of different colors. Optional.

9. An illuminated pop as set forth in claim 8, wherein;
the electrical circuitry may also supports a circular movement (via another switch) of the cap or lens that separates the flashlight from the hollow tube so that when the cap/lens contains a combination of colors, these colors are reflected up into the pop in a spinning motion and subsequently visible from the outside of the pop. This is optional.
